(19) United States
(12) Patent Application Publication
(10) Pub. No.: US 2026/0045474 A1
(43) Pub. Date: Feb. 12, 2026

(54) METHOD OF PRODUCING BATTERY MODULE AND METHOD OF DETECTING IMPREGNATION STATE OF ELECTROLYTIC SOLUTION

(71) Applicant: TOYOTA JIDOSHA KABUSHIKI KAISHA, Toyota-shi (JP)

(72) Inventor: Yoshiro OBAYASHI, Toyota-shi (JP)

(73) Assignee: TOYOTA JIDOSHA KABUSHIKI KAISHA, Toyota-shi (JP)

(21) Appl. No.: 19/191,054

(22) Filed: Apr. 28, 2025

(30) Foreign Application Priority Data
Aug. 8, 2024 (JP) 2024-133214

(51) Int. Cl. H01M 4/04; G01G 19/14; H01M 50/627

(52) U.S. Cl. CPC H01M 4/0416; H01M 50/627; G01G 19/14

(57) ABSTRACT

A method of producing a battery module according to the present disclosure is a method of producing a battery module including an internal space, and an electrode stack housed in the internal space. The method includes starting injection of an electrolytic solution into the internal space, and determining an impregnation state of the electrolytic solution into the electrode stack based on a relative relationship between loads at a plurality of positions spaced apart from each other in the battery module. This configuration makes it possible to provide the method of producing the battery module that can determine the impregnation state of the electrolytic solution into the electrode.

### CROSS-REFERENCE TO RELATED APPLICATION

This application claims priority to Japanese Patent Application No. 2024-133214 filed on Aug. 8, 2024. The disclosure of the above-identified application, including the specification, drawings, and claims, is incorporated by reference herein in its entirety.

### BACKGROUND

### 1. Technical Field

The present disclosure relates to a method of producing a battery module, and a method of detecting the impregnation state of an electrolytic solution.

### 2. Description of Related Art

Japanese Unexamined Patent Application Publication No. 2022-188536 (JP 2022-188536 A) discloses a method of producing a bipolar electricity storage apparatus. The method accelerates the impregnation of an electrode with an electrolytic solution by depressurizing an internal space in which the electrolytic solution is stored.

### SUMMARY

However, in the method of producing a bipolar electricity storage apparatus disclosed in JP 2022-188536 A, it is not possible to detect that the electrode has been sufficiently impregnated with the electrolytic solution. Thus, activating the battery module (bipolar electricity storage apparatus) with the electrode not impregnated with the electrolytic solution may cause a battery failure.

The present disclosure has been made in view of the above circumstances and provides a method of producing a battery module that can determine the impregnation state of an electrolytic solution into an electrode, and a method of detecting the impregnation state of the electrolytic solution in the battery module.

A method of producing a battery module according to an aspect of the present disclosure is a method of producing a battery module including an internal space, and an electrode stack housed in the internal space. The method includes starting injection of an electrolytic solution into the internal space, and determining an impregnation state of the electrolytic solution into the electrode stack based on a relative relationship between loads at a plurality of positions spaced apart from each other in the battery module.

A method of detecting an impregnation state of an electrolytic solution according to an aspect of the present disclosure is a method of detecting an impregnation state of an electrolytic solution into an electrode stack in a battery module including an internal space, and the electrode stack housed in the internal space. The method includes detecting the impregnation state of the electrolytic solution into the electrode stack based on a relative relationship between loads at a plurality of positions spaced apart from each other in the battery module.

The present disclosure can provide the method of producing the battery module that can determine the impregnation state of the electrolytic solution into the electrode, and the method of detecting the impregnation state of the electrolytic solution in the battery module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view of a battery module according to an embodiment of the present disclosure;

FIG. 2 is a sectional view of the battery module according to the embodiment of the present disclosure;

FIG. 3 is a block diagram of a detector according to the embodiment of the present disclosure;

FIG. 4 is a graph showing temporal changes in loads inside the battery module according to the embodiment of the present disclosure; and

FIG. 5 is a flowchart showing a method of producing the battery module according to the embodiment of the present disclosure.

### DETAILED DESCRIPTION OF EMBODIMENTS

Hereinbelow, a specific embodiment of the present disclosure will be described in detail with reference to the drawings. However, the present disclosure is not limited to the following embodiment. In addition, the following description and the drawings are simplified as appropriate to clarify the description.

### Configuration of Battery Module

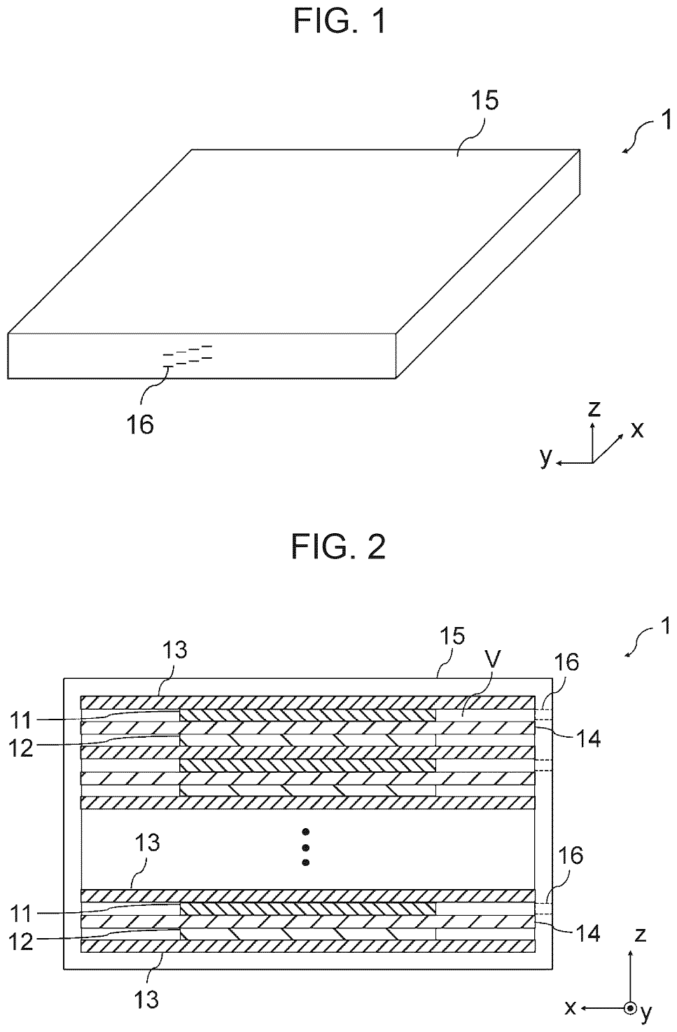

FIG. 1 is a schematic perspective view of a battery module according to the embodiment of the present disclosure. FIG. 2 is a sectional view of the battery module according to the embodiment of the present disclosure.

Note that right-handed xyz Cartesian coordinates shown in FIGS. 1 and 2 are used for convenience to show the positional relationship between the components. In FIGS. 1 and 2, a positive direction of the z-axis is a vertically upward direction and the xy-plane is a horizontal plane, which are common between the drawings.

A battery module 1 includes a positive electrode active material layer 11, a negative electrode active material layer 12, a current collector 13, a separator 14, and a battery case 15. In the battery module 1 shown in FIG. 1, the positive electrode active material layer 11, the negative electrode active material layer 12, the current collector 13, and the separator 14 are stacked to constitute an electrode stack as a whole. In addition, the battery case 15 has an internal space V inside thereof, and includes an injection port 16 that connects the internal space V to the outside. In addition, an electrolytic solution (not shown) is stored in the internal space V.

The battery module 1 is, for example, a secondary battery, such as a lithium-ion secondary battery or a nickel metal hydride battery. Although, in the present embodiment, the battery module 1 is a lithium-ion secondary battery as an example, the type of the battery is not limited thereto. In addition, the number of stacked layers of the positive electrode active material layer 11, the negative electrode active material layer 12, the current collector 13, and the separator 14 inside the battery module 1 is not limited to any particular number, and is determined as appropriate depending on the use.

The positive electrode active material layer 11 is provided on a surface of the current collector 13. The positive electrode active material layer 11 faces the negative electrode active material layer 12 with the separator 14 interposed therebetween. The positive electrode active material layer 11 contains a positive electrode active material, and may further optionally contain an electrolyte, a conductive aid, and a binder. Examples of the positive electrode active material include lithium cobalt oxide, lithium nickel oxide, and lithium manganese oxide.

The negative electrode active material layer 12 is provided on the surface of the current collector 13. The negative electrode active material layer 12 faces the positive electrode active material layer 11 with the separator 14 interposed therebetween. The negative electrode active material layer 12 contains a negative electrode active material, and may further optionally contain an electrolyte, a conductive aid, and a binder. Examples of the negative electrode active material include carbon, graphite, and lithium titanate.

The current collector 13 has any one or more of the positive electrode active material layer 11 and the negative electrode active material layer 12 provided on its surface. The current collector 13 faces the separator 14 with the positive active material layer 11 or the negative active material layer 12 interposed therebetween. Examples of the current collector 13 include aluminum and copper. Note that a part of the current collector 13 may be drawn out and provided outside the battery case 15 to enable connection with an external terminal.

The separator 14 prevents a short circuit between the positive electrode active material layer 11 and the negative electrode active material layer 12. The separator 14 is disposed between the positive electrode active material layer 11 and the negative electrode active material layer 12. The separator 14 is a porous film made of, for example, polyethylene or polypropylene.

The battery case 15 holds, inside thereof, the positive electrode active material layer 11, the negative electrode active material layer 12, the current collector 13, the separator 14, and the electrolytic solution. The battery case 15 is, for example, a metal can or a laminate film made by bonding metal foil and resin such as polypropylene together. Note that although FIG. 1 shows the battery case 15 having a flat plate shape, the shape of the battery case 15 is not limited to any particular shape.

The injection port 16 is provided in a wall of the battery case 15 to inject the electrolytic solution into the internal space V. The injection port 16 connects the internal space V to the outside.

It is preferable that a plurality of injection ports 16 be provided at one side face of the battery module 1 as shown in FIG. 1. With this configuration, it is possible to determine the impregnation state of the electrolytic solution inside the battery module 1 even when the electrolytic solution is injected from the vicinity of an end of the battery module 1 through the injection ports 16. Note that although, in FIG. 1, the injection ports 16 are provided in a face parallel to the yz-plane, the injection ports 16 may be provided in a face parallel to the xz-plane.

The internal space V is provided as a space surrounded by the current collector 13 and the battery case 15. The internal space V is connected to the outside through the injection port 16, and the electrolytic solution is injected into the internal space V. The electrolytic solution to be injected is, for example, lithium hexafluorophosphate, lithium perchlorate, or lithium tetrafluoroborate dissolved in a solvent such as ethylene carbonate, dimethyl carbonate, diethyl carbonate, or ethyl methyl carbonate.

Note that although, in FIG. 1, the stacking direction of the electrode stack including the positive active material layer 11, the negative active material layer 12, the current collector 13, and the separator 14 is the z-axis direction, the stacking direction of the electrode stack may be the x-axis direction or the y-axis direction and is not limited to any particular direction. For example, when the stacking direction is the x-axis direction, the internal spaces V are arranged in the x-axis direction. Thus, the injection ports 16 are provided in the face parallel to the xz-plane or the face parallel to the xy-plane corresponding to the positions of the internal spaces V.

### Configuration of Detector

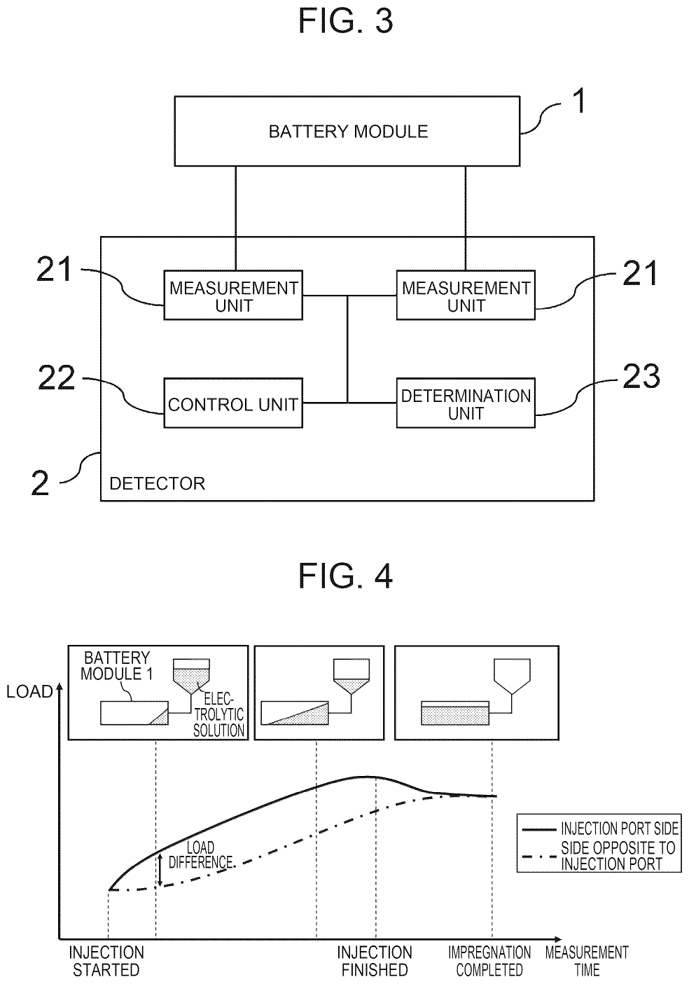

FIG. 3 is a block diagram of a detector according to the embodiment of the present disclosure. A detector 2 shown in FIG. 3 measures loads at a plurality of positions on the xy-plane in the battery module 1, the positions being spaced apart from each other. In addition, the detector 2 determines the impregnation state of the electrolytic solution inside the battery module 1 based on the measured loads. The detector 2 includes a measurement unit 21, a control unit 22, and a determination unit 23. Note that although FIG. 3 shows only one detector 2, a plurality of detectors 2 may be used to measure the loads of the battery module 1 and determine the impregnation state of the electrolytic solution.

The measurement unit 21 is connected to the control unit 22 and the determination unit 23. The measurement unit 21 measures the load of the battery module 1 at a certain position. Examples of a method of measuring the load using the measurement unit 21 include a method that performs the measurement by placing the battery module 1 on a stand on which the measurement unit 21 is disposed, and a method that suspends the battery module 1 using a plurality of measurement units 21. However, the method of measuring the load is not limited to any particular method.

It is preferable that one or more measurement units 21 be disposed on each of the injection port 16 side and the side opposite to the injection port 16 in FIG. 1. By disposing the measurement units 21 at a plurality of positions with different distances from the injection port 16, the accuracy of determining the impregnation state of the electrolytic solution inside the battery module 1 is improved.

Note that although the detector 2 shown in FIG. 3 includes two measurement units 21, the detector 2 may include three or more measurement units 21 or may include one measurement unit 21. For example, when the detector 2 includes four measurement units 21, by disposing the measurement units 21 at four corners of the flat face of the battery module 1, the accuracy of determining the impregnation state of the electrolytic solution inside the battery module 1 is further improved, compared to a case in which only two measurement units 21 are disposed. In addition, even when, for example, the detector 2 includes only one measurement unit 21, it is possible to determine the impregnation state of the electrolytic solution inside the battery module 1 by measuring the loads at a plurality of positions using a plurality of detectors 2.

The control unit 22 is connected to the measurement unit 21 and the determination unit 23. The control unit 22 executes various functions of the detector 2 based on the load of the battery module 1 measured by the measurement unit 21 and the impregnation state of the electrolytic solution inside the battery module 1 determined by the determination unit 23. The control unit 22 includes, for example, a central processing unit (CPU), a micro processing unit (MPU), a working memory, and a nonvolatile storage device that stores control programs. The control unit 22 may include an integrated circuit (IC).

The determination unit 23 is connected to the measurement unit 21 and the control unit 22. The determination unit 23 determines the impregnation state of the electrolytic solution inside the battery module 1 based on the load of the battery module 1 measured by the measurement unit 21. Note that the determination unit 23 may convert the load measured by the measurement unit 21 into another parameter such as weight, pressure, a displacement caused by weight, or an electrical resistance change caused by strain, and use the converted value as load information to determine the impregnation state of the electrolytic solution.

FIG. 4 is a graph showing temporal changes in the loads inside the battery module according to the embodiment of the present disclosure. A solid line shows temporal changes in the load of the battery module 1 on the injection port 16 side, and a long dashed short dashed line shows temporal changes in the load of the battery module 1 on the side opposite to the injection port 16.

The determination unit 23 determines the impregnation state of the electrolytic solution into the electrode stack based on the relative relationship between the loads at the positions spaced apart from each other. Specifically, for example, as shown in FIG. 4, the determination unit 23 calculates the difference between the load measured by the measurement unit 21 disposed on the injection port 16 side and the load measured by the measurement unit 21 disposed on the side opposite to the injection port 16. When the difference is less than a threshold, the determination unit 23 determines that the impregnation of the electrolytic solution inside the battery module 1 has been completed. However, the method of determining completion of the impregnation is not limited to this method. For example, a determination method that measures the loads of the battery module 1 using more than two measurement units 21, and uses whether the difference between the maximum and minimum values of the measured loads is less than a threshold to determine completion of the impregnation may be used. In addition, another parameter such as weight, pressure, a displacement caused by weight, or an electrical resistance change caused by strain may be used instead of the load to determine completion of the impregnation of the electrolytic solution, or a plurality of parameters may be combined to determine completion of the impregnation of the electrolytic solution.

As described above, the detector according to the embodiment of the present disclosure measures the loads of the battery module at the positions spaced apart from each other. This makes it possible to provide the detector that can determine the impregnation state of the electrolytic solution inside the battery module and determine completion of the impregnation of the electrolytic solution.

### Method of Producing Battery Module

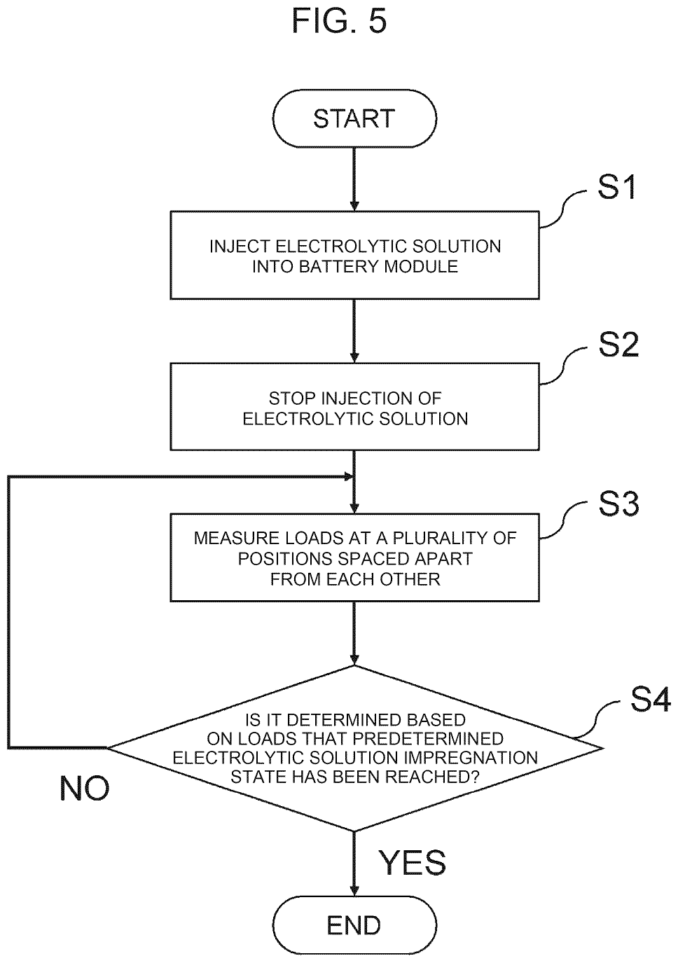

Next, a method of producing the battery module according to the embodiment of the present disclosure and a method of detecting the impregnation state of the electrolytic solution in the battery module will be described with reference to FIG. 5. FIG. 5 is a flowchart showing the method of producing the battery module according to the embodiment of the present disclosure.

First, the electrolytic solution is injected into battery module 1 through the injection port 16 (step S1). As an injection method, for example, the inside of the battery module 1 is depressurized in advance, and a pipe through which the electrolyte passes and a container that stores the electrolytic solution are connected to the injection port 16. This creates a pressure difference between the inside and the outside of the battery module 1, and the electrolytic solution is suctioned and injected into the battery module 1 due to the pressure difference. However, as the injection method, another method such as a method of directly injecting the electrolytic solution through the pipe using, for example, a pump may be used, and the injection method is not limited to any particular method. In addition, the amount and speed of injection of the electrolytic solution are not limited to any particular amount and speed.

Next, after a predetermined amount of electrolytic solution is injected into the battery module 1 in step S1, the injection is stopped (step S2).

Next, the detector 2 measures loads at the positions spaced apart from each other in the battery module 1 (step S3). In step S3, for example, the detector 2 measures the loads of the battery module 1 at two positions of the battery module 1 on the injection port 16 side and the side opposite to the injection port 16. Note that although, in FIG. 5, step S3 in which the detector 2 measures the loads of the battery module 1 is set downstream of step S2 in which the injection is stopped, step S3 may be set upstream of step S2. That is, the detector 2 may measure the loads of the battery module 1 during the injection.

Next, using the loads measured in step S3, the detector 2 determines the impregnation state of the electrolytic solution inside the battery module 1 (step S4). In step S4, for example, the detector 2 calculates the difference between the loads measured at the two positions of the battery module 1 on the injection port 16 side and the side opposite to the injection port 16, and determines whether the difference is less than the threshold. However, as described above, the method of determining completion of the impregnation of the electrolytic solution is not limited to this method.

When the difference between the loads measured in step S3 is less than the threshold (YES in step S4), it is determined that the impregnation of the electrolytic solution inside the battery module 1 has been completed, and the process is finished. On the other hand, when the difference between the measured loads is not less than the threshold (NO in step S4), the process returns to step S3, and values of the loads of the battery module 1 are measured again for the injection port 16 side and the side opposite to the injection port 16 in the battery module 1 after an elapse of a predetermined time. However, the time interval between when the loads of the battery module 1 are measured and when the loads of the battery module 1 are measured again is not limited to any particular time interval.

As described above, the method of producing the battery module according to the embodiment of the present disclosure detects the impregnation state of the electrolytic solution inside the battery module by measuring the loads of the battery module at a plurality of positions, and determines completion of the impregnation of the electrolytic solution. This makes it possible to provide the method of producing the battery module that can determine the impregnation state of the electrolytic solution into the electrode.

What is claimed is:

1. A method of producing a battery module, the battery module including an internal space, and an electrode stack housed in the internal space, the method comprising:
starting injection of an electrolytic solution into the internal space; and
determining an impregnation state of the electrolytic solution into the electrode stack based on a relative relationship between loads at a plurality of positions spaced apart from each other in the battery module.

2. The method according to claim 1, wherein:
the battery module has a flat plate shape; and
in measuring the loads, the loads are measured at the positions spaced apart from each other on a flat face of the battery module.

3. The method according to claim 2, wherein, in the starting of the injection of the electrolytic solution, the injection is performed from a vicinity of an end of the battery module.

4. The method according to claim 1, wherein, when it is determined that the impregnation state of the electrolytic solution reaches a predetermined impregnation state, the injection is stopped.

5. A method of detecting an impregnation state of an electrolytic solution into an electrode stack in a battery module, the battery module including an internal space, and the electrode stack housed in the internal space, the method comprising
detecting the impregnation state of the electrolytic solution into the electrode stack based on a relative relationship between loads at a plurality of positions spaced apart from each other in the battery module.
